(19) United States
(12) Patent Application Publication
(10) Pub. No.: US 2025/0198449 A1
(43) Pub. Date: Jun. 19, 2025

(54) ANTI-LOOSENING SCREW AND DEVICE CONNECTION ASSEMBLY

(71) Applicant: JIANPING LI, FOSHAN (CN)

(72) Inventor: JIANPING LI, FOSHAN (CN)

(21) Appl. No.: 18/811,813

(22) Filed: Aug. 22, 2024

(30) Foreign Application Priority Data
Dec. 15, 2023 (CN) 202323448759.X

(51) Int. Cl. F16B 39/12

(52) U.S. Cl. CPC F16B 39/12

(57) ABSTRACT

An anti-loosening screw and a devices connection assembly relate to a technical field of fasteners. The anti-loosening screw includes a bolt column, a bolt cap, a nut, and a washer arranged between the bolt cap and the nut. The washer is sleeved on the bolt column. A first limiting mechanism is arranged between the washer and the bolt column. The first limiting mechanism is configured to prevent the washer from rotating relative to the bolt column in a circumferential direction of the washer. A second limiting mechanism is arranged between the nut and the washer. The second limiting mechanism is configured to prevent the nut from rotating reversely. The second limiting mechanism includes at least one one-way limiting pin connected with the nut and limiting teeth arranged on the washer. By providing the washer, accidental reverse rotation of the nut and the bolt column after connection is avoided.

### TECHNICAL FIELD

The present disclosure relates to a technical field of fasteners, and in particular to an anti-loosening screw and a device connection assembly.

### BACKGROUND

Fasteners are a general term for a type of mechanical parts configured to fasten two or more parts (or components) into a whole. The fasteners are the mechanical parts configured for fastening and connection and are extremely widely used. Fasteners generally comprise bolts and nuts. After the bolts and nuts are connected, the bolts and nuts are prone to loosening due to shaking and other reasons, which affects stability of a connection effect of the fasteners. Therefore, further improvement is needed.

### SUMMARY

An object of the present disclosure is to overcome defects in prior art and to provide an anti-loosening screw and a device connection assembly, which effectively prevent a nut thereof from loosening and improve connection stability.

To achieve the above object, in a first aspect, the present disclosure provides the anti-loosening screw. The anti-loosening screw comprises a bolt column, a bolt cap, a nut, and a washer. The washer is arranged between the bolt cap and the nut. The washer is sleeved on an outer side of the bolt column. A first limiting mechanism is arranged between the washer and the bolt column. The first limiting mechanism is configured to prevent the washer from rotating relative to the bolt column in a circumferential direction of the washer. A second limiting mechanism is arranged between the nut and the washer. The second limiting mechanism is configured to prevent the nut from rotating reversely. The second limiting mechanism comprises at least one one-way limiting pin connected with the nut and limiting teeth arranged on the washer.

In the embodiment, by providing the washer, accidental reverse rotation of the nut and the bolt column after connection is avoided, thereby preventing the nut and the bolt column from loosening due to shaking or other reason, which improves connection stability of the anti-loosening screw.

In one optional embodiment, the limiting teeth are arranged in the circumferential direction of the washer. A guide inclined surface is defined on a first side of each of the limiting teeth toward a reverse rotation direction of the anti-loosening screw. An inclination direction of the guide inclined surface of each of the limiting teeth is opposite to a threaded direction of the bolt column. A limiting surface is defined on a second side of each of the limiting teeth toward a forward rotation direction of the anti-loosening screw.

In the embodiment, by defining the guide inclined surface and the limiting surface on each of the limiting teeth, when the at least one one-way limiting pin is located between two adjacent limiting teeth of the limiting teeth and when the nut is installed in the forward rotation direction along the threaded direction of the bolt column, the at least one one-way limiting pin abuts against the guide inclined surface of a first one of the two adjacent limiting teeth, so the nut is installed normally without being affected by the limiting teeth. On the contrary, when the nut is hit or subjected to a force in a direction opposite to the threaded direction of the bolt column, the at least one one-way limiting pin abuts against the limiting surface of a second one of the two adjacent limiting teeth, and the at least one one-way limiting pin is limited at a position of the second one of the two adjacent limiting teeth to prevent the nut from loosening.

In one optional embodiment, the limiting teeth are arranged on one side of the washer facing the nut. A connecting surface abutting against the nut is defined on the one side of the washer. A horizontal height of the limiting teeth is not greater than a horizontal height of the connecting surface of the washer.

In the embodiment, by defining the connecting surface on an upper surface of the washer, a contact area between the washer and the nut is increased. After the nut is tightened, a static friction force is generated between the nut and the washer, thereby further enhancing an anti-loosening effect. Moreover, the horizontal height of the limiting teeth is not greater than the horizontal height of the connecting surface of the washer, which prevents the limiting teeth and the nut from contacting, reduces wear of the limiting teeth, and prolongs service life of the anti-loosening screw.

In one optional embodiment, a groove with a predetermined width is formed between a bottom portion of the guide inclined surface of each of the limiting teeth and a bottom portion of the limiting surface of an adjacent limiting tooth, and/or outer sides of the limiting teeth are flush with a side wall of the washer in a radial direction of the washer.

In the embodiment, each groove with the predetermined width is formed between each two adjacent limiting teeth, so that the at least one one-way limiting pin is allowed to be accommodated in any groove, and the at least one one-way limiting pin is allowed to smoothly slide in each two adjacent limiting teeth when installing the nut. Therefore, an interval between each two adjacent limiting teeth is prevented from being too small to affect forward movement of the at least one one-way limiting pin in the threaded direction.

In one optional embodiment, the at least one one-way limiting pin comprises a forward section, a reverse section, and a swing shaft. The swing shaft is arranged between the forward section and the reverse section of the at least one one-way limiting pin. The swing shaft is connected to one side of the nut, and the at least one one-way limiting pin rotates around the swing shaft.

In the embodiment, by providing the at least one one-way limiting pin rotating around the swing shaft, the anti-loosening screw is detachable. During installation, the reverse section of the at least one one-way limiting pin abuts against the guide inclined surface of any one of the limiting teeth, which does not affect a normal installation of the nut. In an anti-loosening process, the reverse section of the at least one-way limiting pin abuts against the limiting surface of a current limiting tooth, so that the nut is effectively prevented from loosening. During disassembly, a tool such as a wrench presses the forward section of the at least one one-way limiting pin, so that the reverse section of the at least one one-way limiting pin tilts upwards to unlock the nut. At this time, the nut is allowed to be rotated reversely to realize the disassembly of the anti-loosening screw without affecting reuse of the anti-loosening screw.

In one optional embodiment, the reverse section of the at least one one-way limiting pin abuts between the two adjacent limiting teeth of the limiting teeth. When the nut rotates in the forward rotation direction, the reverse section of the at least one one-way limiting pin slides along the guide inclined surface of the first one of the two adjacent limiting teeth, so that the at least one one-way limiting pin rotates around the swing shaft, and the reverse section of the at least one one-way limiting pin slides from the guide inclined surface of the first one of the two adjacent limiting teeth to the second one of the two adjacent limiting teeth.

In the embodiment, the reverse section of the at least one one-way limiting pin abuts against the guide inclined surface of the first one of the two adjacent limiting teeth, the at least one one-way limiting pin is not limited by the limiting teeth in the installation process of the nut, and the normal installation of the nut is ensured.

In one optional embodiment, the reverse section of the at least one one-way limiting pin abuts between two adjacent limiting teeth. An abutting inclined surface is defined on an end portion of the reverse section of the at least one one-way limiting pin. When the nut rotates in the reverse rotation direction. The abutting inclined surface of the reverse section of the at least one one-way limiting pin abuts against the limiting surface of a corresponding limiting tooth to prevent the nut from rotating in the reverse rotation direction.

In the embodiment, the abutting inclined surface is defined on the end portion of the reverse section of the at least one one-way limiting pin, and the abutting inclined surface of the reverse section of the at least one one-way limiting pin abuts against the limiting surface of the corresponding limiting tooth, so a contact area thereof is increases, which improves a limiting effect and avoids wear of the at least one one-way limiting pin or the limiting teeth caused by a small contact area.

In one optional embodiment, the swing shaft is connected to a torsion spring. When the torsion spring is in a compressed state, the torsion spring drives the reverse section of the at least one one-way limiting pin to swing toward the washer by resetting.

In the embodiment, the torsion spring in the compressed state provides an elastic force to make the reverse section of the at least one one-way limiting pin being kept in a state of swinging towards the washer, thereby locking the nut by the at least one one-way limiting pin.

In one optional embodiment, the first limiting mechanism comprises at least one limiting groove defined in the bolt column and at least one limiting protrusion arranged on the washer. The at least one limiting groove is defined in a side wall of the bolt column. The at least one limiting protrusion is engaged with the at least one limiting groove.

In the embodiment, since the at least one limiting protrusion is engaged with the at least one limiting groove, the washer is prevented from rotating around the bolt column, and the washer is only allowed to move along an extension direction of the at least one limiting groove.

In one optional embodiment, the at least one limiting groove defines an opening at one end of the bolt column away from the bolt cap. The washer is sleeved on the bolt column from the one end of the bolt column away from the bolt cap, so that the at least one limiting protrusion enters the at least one limiting groove from the opening and moves in the at least one limiting groove.

In the embodiment, the at least one limiting groove defines the opening at the one end of the bolt column away from the bolt cap, so that the at least one limiting protrusion is allowed to enter the at least one limiting groove from the opening and moves along the extension direction of the at least one limiting groove, which facilitates an installation of the washer.

In one optional embodiment, the at least one limiting groove comprises two limiting grooves. The two limiting grooves are axially symmetrically arranged on the bolt column.

In the embodiment, the two limiting grooves that are symmetrically arranged further enhance stability of the washer, thereby preventing the washer from being affected in installation stability when the washer is subjected to a side impact force.

In one optional embodiment, the at least one limiting groove comprises more than two limiting grooves. The more than two limiting grooves are arranged on the bolt column at equal intervals along a circumferential direction of the bolt column.

In the embodiment, by arranging the more than two limiting grooves on the bolt column at equal intervals along the circumferential direction of the bolt column, the installation stability of the washer is prevented from being affected when subjected to the side impact force.

In one optional embodiment, the bolt column has a cross section having a predetermined limiting shape. The washer comprises a through hole having a shape matched with the cross section of the bolt column.

In the embodiment, by arranging the bolt column has the cross section having the predetermined limiting shape and the through hole having the shape matched with the cross section of the bolt column, after the washer defining the through hole is installed on the bolt column, the washer is only allowed to move in a vertical installation direction, avoiding a failure of the anti-loosening effect caused by a rotation of the washer.

In one optional embodiment, the predetermined limiting shape of the cross section of the bolt column is D-shaped. The bolt column defines a vertical limiting surface.

In the embodiment, the bolt column having the D-shaped cross section defines the vertical limiting surface. After the washer is installed, the vertical limiting surface of the bolt column abuts against an inner wall of the through hole, so the washer is only allowed to move in the vertical installation direction, avoiding the failure of the anti-loosening effect caused by the rotation of the washer.

In one optional embodiment, the predetermined limiting shape of the cross section of the bolt column is capsule-shaped. The bolt column defines two vertical limiting surfaces parallel to each other.

In the embodiment, the bolt column having the capsule-shaped cross section defines the two vertical limiting surfaces. The two vertical limiting surfaces of the bolt column abut against the inner wall of the through hole, so the washer is only allowed to move in the vertical installation direction, avoiding the failure of the anti-loosening effect caused by the rotation of the washer.

In one optional embodiment, the predetermined limiting shape of the cross section of the bolt column is cross-shaped or star-shaped. End portions of the cross section of the bolt column are circular arcs with a same radius, the bolt column defines vertical grooves facing a center of the bolt column.

In the embodiment, the vertical grooves abut against the inner wall of the through hole, so the washer is only allowed to move in the vertical installation direction, avoiding the failure of the anti-loosening effect caused by the rotation of the washer.

In one optional embodiment, a sleeving ring is sleeved on an outer side of the nut. An inner side of the sleeving ring abuts against the outer side of the nut, and the at least one one-way limiting pin is installed on an outer side wall of the sleeving ring.

In the embodiment, the at least one one-way limiting pin does not need to be installed on the nut, so the nut is allowed to be a common-used nut, which improves versatility of the anti-loosening screw.

In one optional embodiment, an accommodating groove is defined in an upper end surface of the sleeving ring, and the sleeving ring is sleeved with the nut through the accommodating groove. A fixed hole is defined in a center of the sleeving ring. A diameter of the fixed hole is not less than a diameter of the bolt column.

In the embodiment, the sleeving ring defines the accommodating groove for sleeving the nut, making a connection between the nut and the sleeving ring more smooth. At the same time, the fixed hole is defined in the center of the sleeving ring, which provide a moving space for the bolt column.

In one optional embodiment, the sleeving ring is integrally molded with the nut and the sleeving ring is fixedly connected to the nut.

In one optional embodiment, the at least one one-way limiting pin comprises two or more one-way limiting pins. When two one-way limiting pins are provided, the two one-way limiting pins are symmetrically arranged on the sleeving ring. Alternatively, when more than two one-way limiting pins are provided, the more than two one-way limiting pins are arranged on the sleeving ring at equal intervals along a circumferential direction of the sleeving ring.

In the embodiment, a tightening effect on the nut is further enhanced by the at least two one-way limiting pins to avoid loosening of the anti-loosening screw when the anti-loosening screw is subjected to the side impact force.

In a second aspect, the present disclosure provides the device connection assembly. The device connection assembly comprises at least two anti-loosening screws mentioned above.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of an anti-loosening screw according to a first embodiment of the present disclosure.

FIG. 2 is another schematic diagram of the anti-loosening screw according to the first embodiment of the present disclosure.

FIG. 3 is an exploded schematic diagram of the anti-loosening screw according to the first embodiment of the present disclosure.

FIG. 4 is an enlarged schematic diagram of portion A shown in FIG. 1.

FIG. 5 is an enlarged schematic diagram of portion B shown in FIG. 2.

FIG. 6 is an exploded schematic diagram of the anti-loosening screw according to a second embodiment of the present disclosure.

FIG. 7 is an exploded schematic diagram of the anti-loosening screw according to a third embodiment of the present disclosure.

FIG. 8 is another exploded schematic diagram of the anti-loosening screw according to the third embodiment of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

It should be noted that if the embodiments of the present disclosure involve directional indications (such as up, down, left, right, front, back, etc.), the directional indications are only used to explain the relative position relationship, movement status, etc. between the components in a certain specific posture. If the specific posture changes, the directional indications change accordingly.

In addition, should be understood in the embodiments of the present disclosure that terms such as “first” and “second” are only used for the purpose of description, rather than being understood to indicate or imply relative importance or hint the number of indicated technical features. Thus, the feature limited by “first” and “second” can explicitly or impliedly include one or more features. In addition, the term “and/or” depict relationship between associated objects and there are three relationships thereon. For example, A and/or B may indicate A exists alone, A and B exist at the same time, and B exists alone. In addition, the technical solutions between the various embodiments may be combined with each other, but the combination should be realized by those skilled in the art. When the combination of the technical solutions is contradictory or cannot be implemented, it should be considered that the combination of the technical solutions does not exist or is not within the protection scope of the present disclosure.

### Embodiment 1

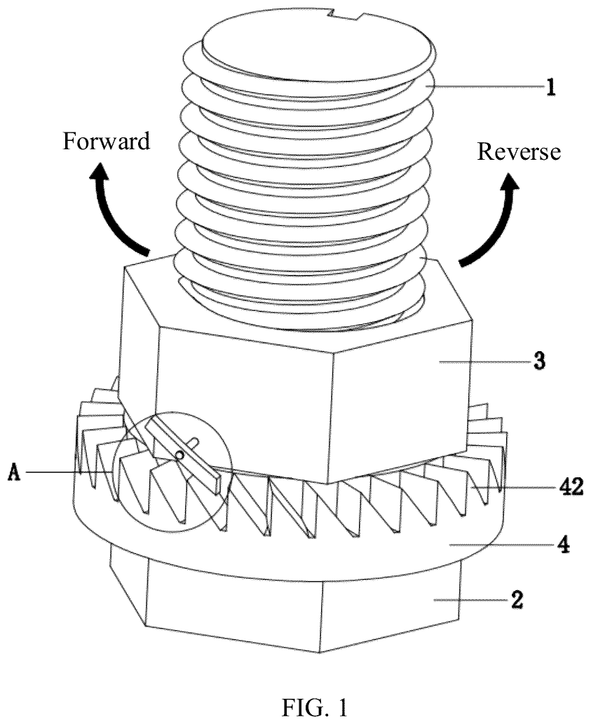

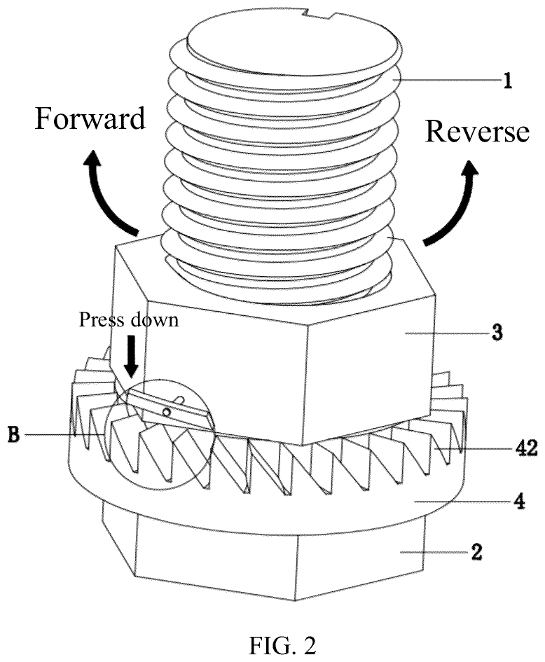

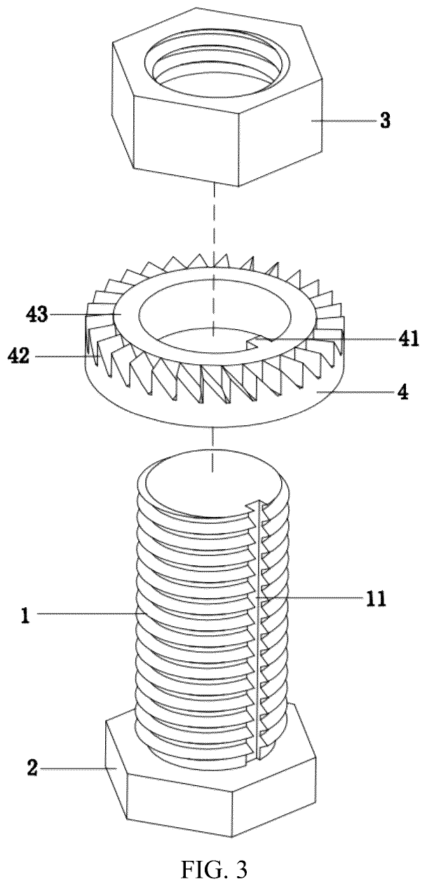

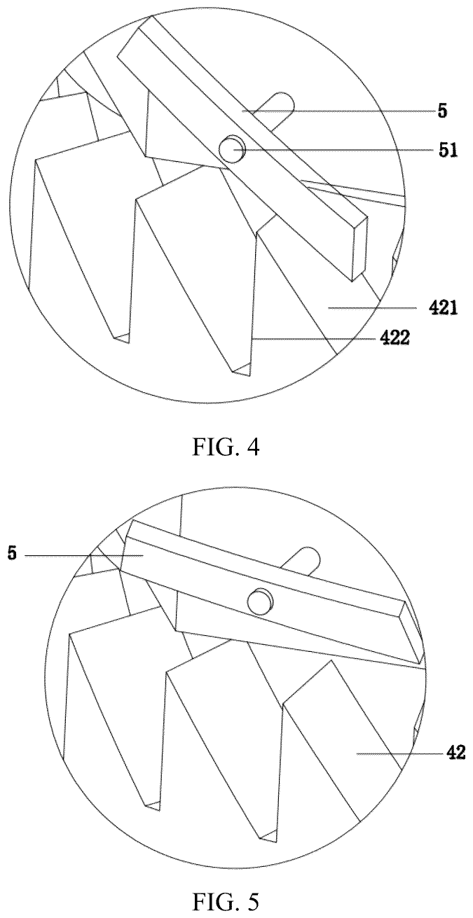

As shown in FIGS. 1-5, the present disclosure provides an anti-loosening screw. The anti-loosening screw comprises a bolt column 1, a bolt cap 2, a nut 3, and a washer 4. The washer 4 is arranged between the bolt cap 2 and the nut 3. The washer 4 is sleeved on an outer side of the bolt column 1. A first limiting mechanism is arranged between the washer 4 and the bolt column 4. The first limiting mechanism is configured to prevent the washer 4 from rotating relative to the bolt column 1 in a circumferential direction of the washer 4. A second limiting mechanism is arranged between the nut and the washer. The second limiting mechanism is configured to prevent the nut 3 from rotating reversely. The second limiting mechanism comprises at least one one-way limiting pin 5 connected with the nut 3 and limiting teeth 42 arranged on the washer 4.

In the embodiment, by providing the washer 4, accidental reverse rotation of the nut 3 and the bolt column 1 after connection is avoided, thereby preventing the nut 3 and the bolt column 1 from loosening due to shaking or other reason, which improves connection stability of the anti-loosening screw.

In one optional application scenarios of the embodiment, the limiting teeth 42 are arranged in the circumferential direction of the washer 4. A guide inclined surface 421 is defined on a first side of each of the limiting teeth 42 toward a reverse rotation direction of the anti-loosening screw. An inclination direction of the guide inclined surface 421 of each of the limiting teeth is opposite to a threaded direction of the bolt column 1. A limiting surface 422 is defined on a second side of each of the limiting teeth 42 toward a forward rotation direction of the anti-loosening screw.

In the embodiment, by defining the guide inclined surface 421 and the limiting surface 422 on each of the limiting teeth 42, when the at least one one-way limiting pin 5 is located between two adjacent limiting teeth 42 of the limiting teeth 42 and when the nut 3 is installed in the forward rotation direction along the threaded direction of the bolt column 1, the at least one one-way limiting pin 5 abuts against the guide inclined surface 421 of a first one of the two adjacent limiting teeth 42, so the nut is installed normally without being affected by the limiting teeth 42. On the contrary, when the nut 3 is hit or subjected to a force in a direction opposite to the threaded direction of the bolt column 1, the at least one one-way limiting pin 5 abuts against the limiting surface 422 of a second one of the two adjacent limiting teeth 42, and the at least one one-way limiting pin 5 is limited at a position of the second one of the two adjacent limiting teeth 42 to prevent the nut 3 from loosening.

In one optional application scenarios of the embodiment, the limiting teeth 42 are arranged on one side of the washer 4 facing the nut 3. A connecting surface 43 abutting against the nut 3 is defined on the one side of the washer 4. A horizontal height of the limiting teeth 42 is not greater than a horizontal height of the connecting surface 43 of the washer 4.

In the embodiment, by defining the connecting surface 43 on an upper surface of the washer 4, a contact area between the washer 4 and the nut 3 is increased. After the nut 3 is tightened, a static friction force is generated between the nut 3 and the washer 4, thereby further enhancing an anti-loosening effect. Moreover, the horizontal height of the limiting teeth 42 is not greater than the horizontal height of the connecting surface 43 of the washer 4, which prevents the limiting teeth 42 and the nut 3 from contacting, reduces wear of the limiting teeth 42, and prolongs service life of the anti-loosening screw.

In one optional application scenarios of the embodiment, a groove with a predetermined width is formed between a bottom portion of the guide inclined surface 421 of each of the limiting teeth 42 and a bottom portion of the limiting surface 422 of an adjacent limiting tooth 42, and/or outer sides of the limiting teeth 42 are flush with a side wall of the washer 4 in a radial direction of the washer 4.

In the embodiment, each groove with the predetermined width is formed between each two adjacent limiting teeth 42, so that the at least one one-way limiting pin 5 is allowed to be accommodated in any groove, and the at least one one-way limiting pin 5 is allowed to smoothly slide in each two adjacent limiting teeth 42 when installing the nut 3. Therefore, an interval between each two adjacent limiting teeth 42 is prevented from being too small to affect forward movement of the at least one one-way limiting pin 5 in the threaded direction.

In one optional application scenarios of the embodiment, the at least one one-way limiting pin 5 comprises a forward section, a reverse section, and a swing shaft 51. The swing shaft 51 is arranged between the forward section and the reverse section of the at least one one-way limiting pin 5. The swing shaft 51 is connected to one side of the nut 3, and the at least one one-way limiting pin 5 rotates around the swing shaft 51.

In the embodiment, by providing the at least one one-way limiting pin rotating around the swing shaft, the anti-loosening screw is detachable. During installation, the reverse section of the at least one one-way limiting pin 5 abuts against the guide inclined surface 421 of any one of the limiting teeth 42, which does not affect a normal installation of the nut 3. In an anti-loosening process, the reverse section of the at least one-way limiting pin abuts against the limiting surface of a current limiting tooth, so that the nut 3 is effectively prevented from loosening. During disassembly, a tool such as a wrench presses the forward section of the at least one one-way limiting pin 5, so that the reverse section of the at least one one-way limiting pin 5 tilts upwards to unlock the nut 3. At this time, the nut 3 is allowed to be rotated reversely to realize the disassembly of the anti-loosening screw without affecting reuse of the anti-loosening screw.

In one optional application scenarios of the embodiment, the reverse section of the at least one one-way limiting pin 5 abuts between the two adjacent limiting teeth 42 of the limiting teeth 42. When the nut 3 rotates in the forward rotation direction, the reverse section of the at least one one-way limiting pin 5 slides along the guide inclined surface 421 of the first one of the two adjacent limiting teeth 42, so that the at least one one-way limiting pin 5 rotates around the swing shaft 51, and the reverse section of the at least one one-way limiting pin 5 slides from the guide inclined surface 421 of the first one of the two adjacent limiting teeth 42 to the second one of the two adjacent limiting teeth 42.

In the embodiment, the reverse section of the at least one one-way limiting pin 5 abuts against the guide In one optional application scenarios of the embodiment, the reverse section of the at least one one-way limiting pin abuts between the two adjacent limiting teeth of the limiting teeth. When the nut rotates in the forward rotation direction, the reverse section of the at least one one-way limiting pin slides along the guide inclined surface of the first one of the two adjacent limiting teeth, so that the at least one one-way limiting pin rotates around the swing shaft, and the reverse section of the at least one one-way limiting pin slides from the guide inclined surface of the first one of the two adjacent limiting teeth to the second one of the two adjacent limiting teeth.

In the embodiment, the reverse section of the at least one one-way limiting pin abuts against the guide inclined surface 421 of the first one of the two adjacent limiting teeth 42, the at least one one-way limiting pin 5 is not limited by the limiting teeth 42 in the installation process of the nut 3. Under an action of the guide inclined surface 421 of each of the limiting teeth, the washer 4 does not hinder the forward rotation of the nut 3, that is, the nut 3 is allowed to normally move in a direction close to the bolt cap 2 to lock the nut 3.

In one optional application scenarios of the embodiment, the reverse section of the at least one one-way limiting pin 5 abuts between two adjacent limiting teeth 42. An abutting inclined surface is defined on an end portion of the reverse section of the at least one one-way limiting pin. When the nut 3 rotates in the reverse rotation direction. The abutting inclined surface of the reverse section of the at least one one-way limiting pin 5 abuts against the limiting surface 422 of a corresponding limiting tooth 42 to prevent the nut 3 from rotating in the reverse rotation direction.

In the embodiment, the abutting inclined surface is defined on the end portion of the reverse section of the at least one one-way limiting pin 5, and the abutting inclined surface of the reverse section of the at least one one-way limiting pin 5 abuts against the limiting surface of the corresponding limiting tooth 42, so a contact area thereof is increases, which improves a limiting effect and avoids wear of the at least one one-way limiting pin or the limiting teeth caused by a small contact area. Even if the nut shakes, no reverse rotation occurs, s the nut does not move in the direction away from the bolt cap 2, thereby avoiding accidental loosening of the anti-loosening screw.

When the nut 3 needs to be loosened, it only needs to press the forward section of the at least one one-way limiting pin 5 to tilt the reverse section of the at least one one-way limiting pin 5 upward through the tool such as the wrench, and then the nut 3 is allowed to be twisted reversely through the wrench.

In one optional application scenarios of the embodiment, the swing shaft 51 is connected to a torsion spring. When the torsion spring is in a compressed state, the torsion spring drives the reverse section of the at least one one-way limiting pin 5 to swing toward the washer 4 by resetting.

In the embodiment, the torsion spring in the compressed state provides an elastic force to make the reverse section of the at least one one-way limiting pin 5 being kept in a state of swinging towards the washer 4, thereby locking the nut 3 by the at least one one-way limiting pin 5. That is, the torsion spring drives the reverse section of the at least one one-way limiting pin 5 to swing toward the washer 4 by resetting, so that the at least one one-way limiting pin 5 has a rebound effect. The reverse section of the at least one one-way limiting pin 5 is automatically locked with the washer 4 under an action of the torsion spring. The at least one one-way limiting pin 5 is separated from the corresponding limiting tooth 42 by pressing the forward section pf the at least one one-way limiting pin 5 through the tool to realize an unlock function, so that the nut is allowed to be unscrewed. The torsion spring further improves a locking effect of the at least one one-way limiting pin 5 on limiting a relative position between the nut 3 and the washer 4.

In one optional application scenarios of the embodiment, the first limiting mechanism comprises at least one limiting groove 11 defined in the bolt column 1 and at least one limiting protrusion 41 arranged on the washer 4. The at least one limiting groove 11 is defined in a side wall of the bolt column 1. The at least one limiting protrusion 41 is engaged with the at least one limiting groove 11.

In the embodiment, since the at least one limiting protrusion 41 is engaged with the at least one limiting groove 11, the washer 4 is prevented from rotating around the bolt column 1, and the washer 4 is only allowed to move along an extension direction of the at least one limiting groove 11.

In one optional application scenarios of the embodiment, the at least one limiting groove 11 defines an opening at one end of the bolt column away from the bolt cap. The washer 4 is sleeved on the bolt column 1 from the one end of the bolt column 1 away from the bolt cap 2, so that the at least one limiting protrusion 41 enters the at least one limiting groove 11 from the opening and moves in the at least one limiting groove 11.

In the embodiment, the at least one limiting groove 11 defines the opening at the one end of the bolt column 1 away from the bolt cap 2, so that the at least one limiting protrusion 41 is allowed to enter the at least one limiting groove 11 from the opening and moves along the extension direction of the at least one limiting groove 11, which facilitates an installation of the washer 4.

In one optional application scenarios of the embodiment, the at least one limiting groove 11 comprises two limiting grooves 11. The two limiting grooves 11 are axially symmetrically arranged on the bolt column 1.

In the embodiment, the two limiting grooves 11 that are symmetrically arranged further enhance stability of the washer 4, thereby preventing the washer 4 from being affected in installation stability when the washer 4 is subjected to a side impact force.

In one optional application scenarios of the embodiment, the at least one limiting groove 11 comprises more than two limiting grooves 11. The more than two limiting grooves 11 are arranged on the bolt column 1 at equal intervals along a circumferential direction of the bolt column 1.

In the embodiment, by arranging the more than two limiting grooves 11 on the bolt column 1 at equal intervals along the circumferential direction of the bolt column 1, the installation stability of the washer 4 is prevented from being affected when subjected to the side impact force.

### Embodiment 2

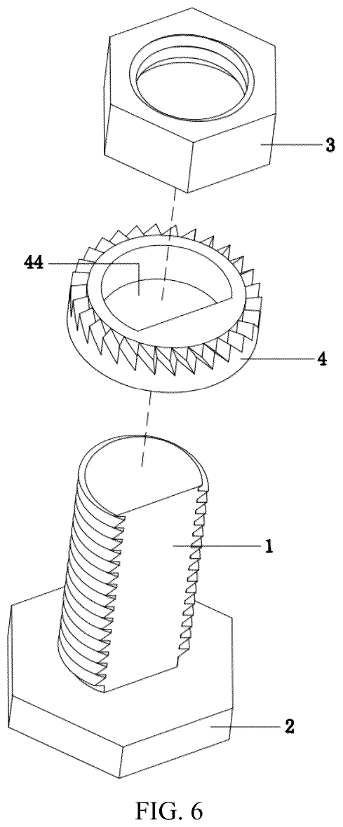

In the embodiment, as shown in FIG. 6, in one optional embodiment, the bolt column 1 has a cross section having a predetermined limiting shape. The washer 4 comprises a through hole 44 having a shape matched with the cross section of the bolt column.

In the embodiment, by arranging the bolt column has the cross section having the predetermined limiting shape and the through hole having the shape matched with the cross section of the bolt column, after the washer 4 defining the through hole 44 is installed on the bolt column 1, the washer 4 is only allowed to move in a vertical installation direction, avoiding a failure of the anti-loosening effect caused by a rotation of the washer 4.

In one optional application scenarios of the embodiment, the predetermined limiting shape of the cross section of the bolt column 1 is D-shaped. The bolt column 1 defines a vertical limiting surface.

In the embodiment, the bolt column 1 having the D-shaped cross section defines the vertical limiting surface. After the washer 4 is installed, the vertical limiting surface of the bolt column 1 abuts against an inner wall of the through hole, so the washer 4 is only allowed to move in the vertical installation direction, avoiding the failure of the anti-loosening effect caused by the rotation of the washer.

In one optional application scenarios of the embodiment, the predetermined limiting shape of the cross section of the bolt column 1 is capsule-shaped. The bolt column 1 defines two vertical limiting surfaces parallel to each other.

In the embodiment, the bolt column 1 having the capsule-shaped cross section defines the two vertical limiting surfaces. The two vertical limiting surfaces of the bolt column 1 abut against the inner wall of the through hole 44, so the washer 4 is only allowed to move in the vertical installation direction, avoiding the failure of the anti-loosening effect caused by the rotation of the washer 4.

In one optional application scenarios of the embodiment, the predetermined limiting shape of the cross section of the bolt column 1 is cross-shaped or star-shaped. End portions of the cross section of the bolt column 1 are circular arcs with a same radius. The bolt column defines vertical grooves facing a center of the bolt column.

In the embodiment, the vertical grooves abut against the inner wall of the through hole 44, so the washer 4 is only allowed to move in the vertical installation direction, avoiding the failure of the anti-loosening effect caused by the rotation of the washer 4.

### Embodiment 3

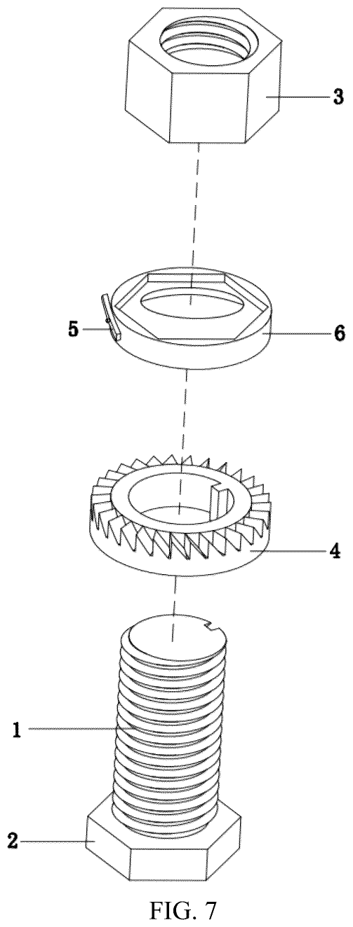

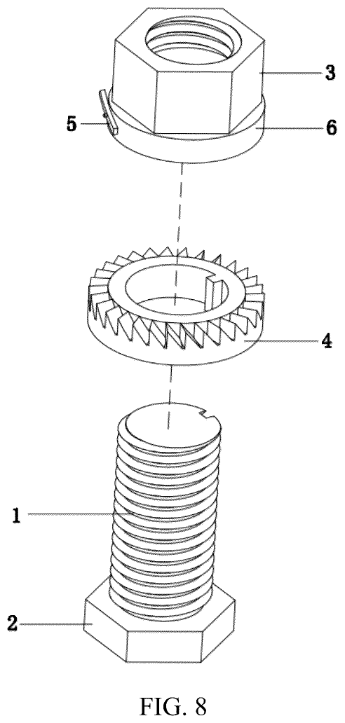

As shown in FIGS. 7 and 8, in one optional application scenarios of the embodiment, a sleeving ring 6 is sleeved on an outer side of the nut 3. An inner side of the sleeving ring 6 abuts against the outer side of the nut 3, and the at least one one-way limiting pin 5 is installed on an outer side wall of the sleeving ring 6.

In the embodiment, the at least one one-way limiting pin 5 does not need to be installed on the nut 3, the nut 3 is allowed to be a common-used nut, which improves versatility of the anti-loosening screw.

In one optional application scenarios of the embodiment, an accommodating groove is defined in an upper end surface of the sleeving ring 6, and the sleeving ring 6 is sleeved with the nut 3 through the accommodating groove. A fixed hole is defined in a center of the sleeving ring 6. A diameter of the fixed hole is not less than a diameter of the bolt column 1.

In the embodiment, the sleeving ring 6 defines the accommodating groove for sleeving the nut 3, making a connection between the nut and the sleeving ring more smooth. At the same time, the fixed hole is defined in the center of the sleeving ring 6, which provide a moving space for the bolt column 1.

In one optional application scenarios of the embodiment, the sleeving ring 6 is integrally molded with the nut 3 and the sleeving ring 6 is fixedly connected to the nut 3.

In one optional application scenarios of the embodiment, the at least one one-way limiting pin 5 comprises two or more one-way limiting pins 5. When two one-way limiting pins 5 are provided, the two one-way limiting pins 5 are symmetrically arranged on the sleeving ring 6. Alternatively, when more than two one-way limiting pins 5 are provided, the more than two one-way limiting pins 5 are arranged on the sleeving ring 6 at equal intervals along a circumferential direction of the sleeving ring 6.

In the embodiment, a tightening effect on the nut 3 is further enhanced by the at least two one-way limiting pins 5 to avoid loosening of the anti-loosening screw when the anti-loosening screw is subjected to the side impact force.

In one optional embodiment, the present disclosure provides a device connection assembly. The device connection assembly comprises at least two anti-loosening screws mentioned above.

The above description is only optional embodiments of the present disclosure, and does not limit the patent scope of the present disclosure. All equivalent structural transformations made by using contents of the specification and the drawings under public concept of the present disclosure, or direct/indirect application in other related technical fields are included in the protection scope of the present disclosure.

What is claimed is:

1. An anti-loosening screw, comprising:
a bolt column,
a bolt cap,
a nut, and
a washer;
wherein the washer is arranged between the bolt cap and the nut; the washer is sleeved on an outer side of the bolt column; a first limiting mechanism is arranged between the washer and the bolt column; the first limiting mechanism is configured to prevent the washer from rotating relative to the bolt column in a circumferential direction of the washer; a second limiting mechanism is arranged between the nut and the washer; the second limiting mechanism is configured to prevent the nut from rotating reversely; the second limiting mechanism comprises at least one one-way limiting pin connected with the nut and limiting teeth arranged on the washer.

2. The anti-loosening screw according to claim 1, wherein the limiting teeth are arranged in the circumferential direction of the washer; a guide inclined surface is defined on a first side of each of the limiting teeth toward a reverse rotation direction of the anti-loosening screw; an inclination direction of the guide inclined surface of each of the limiting teeth is opposite to a threaded direction of the bolt column; a limiting surface is defined on a second side of each of the limiting teeth toward a forward rotation direction of the anti-loosening screw.

3. The anti-loosening screw according to claim 2, wherein the limiting teeth are arranged on one side of the washer facing the nut; a connecting surface abutting against the nut is defined on the one side of the washer; a horizontal height of the limiting teeth is not greater than a horizontal height of the connecting surface of the washer.

4. The anti-loosening screw according to claim 2, wherein a groove with a predetermined width is formed between a bottom portion of the guide inclined surface of each of the limiting teeth and a bottom portion of the limiting surface of an adjacent limiting tooth; and/or
outer sides of the limiting teeth are flush with a side wall of the washer in a radial direction of the washer.

5. The anti-loosening screw according to claim 2, wherein the at least one one-way limiting pin comprises a forward section, a reverse section, and a swing shaft; the swing shaft is arranged between the forward section and the reverse section of the at least one one-way limiting pin; the swing shaft is connected to one side of the nut, and the at least one one-way limiting pin rotates around the swing shaft.

6. The anti-loosening screw according to claim 5, wherein the reverse section of the at least one one-way limiting pin abuts between two adjacent limiting teeth of the limiting teeth; when the nut rotates in the forward rotation direction, the reverse section of the at least one one-way limiting pin slides along the guide inclined surface of a first one of the two adjacent limiting teeth, so that the at least one one-way limiting pin rotates around the swing shaft, and the reverse section of the at least one one-way limiting pin slides from the guide inclined surface of the first one of the two adjacent limiting teeth to a second one of the two adjacent limiting teeth.

7. The anti-loosening screw according to claim 5, wherein the reverse section of the at least one one-way limiting pin abuts between two adjacent limiting teeth, an abutting inclined surface is defined on an end portion of the reverse section of the at least one one-way limiting pin; when the nut rotates in the reverse rotation direction, the abutting inclined surface of the reverse section of the at least one one-way limiting pin abuts against the limiting surface of a corresponding limiting tooth to prevent the nut from rotating in the reverse rotation direction.

8. The anti-loosening screw according to claim 5, wherein the swing shaft is connected to a torsion spring; when the torsion spring is in a compressed state, the torsion spring drives the reverse section of the at least one one-way limiting pin to swing toward the washer by resetting.

9. The anti-loosening screw according to claim 1, wherein the first limiting mechanism comprises at least one limiting groove defined in the bolt column and at least one limiting protrusion arranged on the washer; the at least one limiting groove is defined in a side wall of the bolt column; the at least one limiting protrusion is engaged with the at least one limiting groove.

10. The anti-loosening screw according to claim 9, wherein the at least one limiting groove defines an opening at one end of the bolt column away from the bolt cap; the washer is sleeved on the bolt column from the one end of the bolt column away from the bolt cap, so that the at least one limiting protrusion enters the at least one limiting groove from the opening and moves in the at least one limiting groove.

11. The anti-loosening screw according to claim 10, wherein the at least one limiting groove comprises two limiting grooves; the two limiting grooves are axially symmetrically arranged on the bolt column.

12. The anti-loosening screw according to claim 10, wherein the at least one limiting groove comprises more than two limiting grooves; the more than two limiting grooves are arranged on the bolt column at equal intervals along a circumferential direction of the bolt column.

13. The anti-loosening screw according to claim 1, wherein the bolt column has a cross section having a predetermined limiting shape; the washer comprises a through hole having a shape matched with the cross section of the bolt column.

14. The anti-loosening screw according to claim 13, wherein the predetermined limiting shape of the cross section of the bolt column is D-shaped; the bolt column defines a vertical limiting surface.

15. The anti-loosening screw according to claim 13, wherein the predetermined limiting shape of the cross section of the bolt column is capsule-shaped; the bolt column defines two vertical limiting surfaces parallel to each other.

16. The anti-loosening screw according to claim 13, wherein the predetermined limiting shape of the cross section of the bolt column is cross-shaped or star-shaped; end portions of the cross section of the bolt column are circular arcs with a same radius; the bolt column defines vertical grooves facing a center of the bolt column.

17. The anti-loosening screw according to claim 1, wherein a sleeving ring is sleeved on an outer side of the nut; an inner side of the sleeving ring abuts against the outer side of the nut, and the at least one one-way limiting pin is installed on an outer side wall of the sleeving ring.

18. The anti-loosening screw according to claim 17, wherein an accommodating groove is defined in an upper end surface of the sleeving ring, and the sleeving ring is sleeved with the nut through the accommodating groove; a fixed hole is defined in a center of the sleeving ring; a diameter of the fixed hole is not less than a diameter of the bolt column.

19. The anti-loosening screw according to claim 17, wherein the at least one one-way limiting pin comprises two or more one-way limiting pins;
when two one-way limiting pins are provided, the two one-way limiting pins are symmetrically arranged on the sleeving ring; or
when more than two one-way limiting pins are provided, the more than two one-way limiting pins are arranged on the sleeving ring at equal intervals along a circumferential direction of the sleeving ring.

20. A device connection assembly, comprising: at least two anti-loosening screws according to claim 1.
